(19) United States
(12) Patent Application Publication
(10) Pub. No.: US 2010/0255280 A1
(43) Pub. Date: Oct. 7, 2010

(54) OXIDE FILM, COATING SOLUTION FOR FORMING OXIDE FILM, OPTICAL MEMBER USING THE OXIDE FILM, AND METHOD OF PRODUCING THE OPTICAL MEMBER

(75) Inventors: Yoshinori Kotani, Yokohama-shi (JP); Masayuki Yamada, Tokyo (JP); Hiroyuki Tanaka, Kawasaki-shi (JP); Tetsuya Hiraide, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/679,107

(22) PCT Filed: Dec. 9, 2008
(86) PCT No.: PCT/JP2008/072728

§ 371 Date: Mar. 19, 2010

(30) Foreign Application Priority Data
Dec. 10, 2007 (JP) 2007-318955
Dec. 3, 2008 (JP) 2008-308625

(51) Int. Cl. C09D 5/00; C01B 33/20; C01B 33/26; G02B 1/10; B32B 9/00

(52) U.S. Cl. 428/220; 423/326; 423/325; 423/327.1; 106/287.12; 106/287.17; 428/446

(57) ABSTRACT

Provided is an oxide film including an Si component, in which a relative intensity ratio B/A of an absorption peak intensity B at a wavenumber of 1,000 to 850 cm⁻¹ assigned to an Si—O-M bond where M represents H or a metal element to an absorption peak intensity A at a wavenumber of 1,200 to 1,000 cm⁻¹ assigned to an Si—O bond in infrared absorption spectrum measurement of the film is 0.86 or more to 1.02 or less and an optical member using the oxide film are provided. The oxide film shows suppressed fluctuations in its characteristics even when left to stand under a high-temperature, high-humidity environment for a long time period; has significantly improved durability; and is stable over a long time period and an optical member using the oxide film.

### TECHNICAL FIELD

The present invention relates to an oxide film, a coating solution for forming the oxide film, an optical member using the oxide film, and a method of producing the optical member.

### BACKGROUND ART

The following procedure has been conventionally adopted: an oxide film containing an Si component or Ti component is formed on a base material so that the base material may be provided with desired optical characteristics. Any one of the various formation methods such as dry methods typified by a vacuum vapor deposition method and wet methods typified by a sol-gel method has been employed as a method of forming the oxide film.

Generally known examples of the oxide film containing an Si component include silica-based films, and various methods have been known as methods of forming those films; the sol-gel method has been frequently employed.

Japanese Patent No. 2956305 proposes an insulating film formed of silicon oxide and titanium oxide by the sol-gel method.

In addition, Japanese Patent Application Laid-Open No. 2004-354700 and Japanese Patent Application Laid-Open No. 2005-172896 each propose the following: the extent to which a polymer is formed is monitored in a hydrolytic liquid or coating solution, and such liquid is used so that a silica layer excellent in physical properties may be obtained.

### DISCLOSURE OF THE INVENTION

However, when the above-mentioned conventional oxide film is left to stand under a high-temperature, high-humidity environment for a long time period, it is difficult to suppress the fluctuation or deterioration of the optical characteristics of the film.

Accordingly, an oxide film formed by employing the sol-gel method or the like which: has improved durability; and can maintain stable characteristics over a long time period has been demanded.

The present invention has been made in view of such background art, and an object of the present invention is to provide an oxide film which: shows suppressed fluctuations in characteristics of the film even when left to stand under a high-temperature, high-humidity environment for a long time period; has significantly improved durability; and is stable over a long time period.

An oxide film for solving the problems includes an Si component, in which a relative intensity ratio B/A of an absorption peak intensity B at a wavenumber of 1,000 to 850 cm⁻¹ assigned to an Si—O-M bond where M represents H or a metal element to an absorption peak intensity A at a wavenumber of 1,200 to 1,000 cm⁻¹ assigned to an Si—O bond in infrared absorption spectrum measurement of the film is 0.86 or more to 1.02 or less.

An optical member for solving the problems includes the oxide film described above on a base material.

A coating solution for solving the problems, which is used for forming an oxide film containing an Si component, in which a relative intensity ratio D/C of an infrared absorption peak intensity D assigned to any one stabilizer in a coordinated state to an infrared absorption peak intensity C assigned to an Si—O bond is 0.0005 or more to 0.0500 or less.

A method of producing an optical member for solving the problems includes applying a coating solution prepared so that a relative intensity ratio D/C of an infrared absorption peak intensity D assigned to any one stabilizer in a coordinated state to an infrared absorption peak intensity C assigned to an Si—O bond is 0.0005 or more to 0.0500 or less onto a base material to form an oxide film.

According to the present invention, there can be provided an oxide film which: shows suppressed fluctuations in characteristics of the film even when left to stand under a high-temperature, high-humidity environment for a long time period; has significantly improved durability; and is stable over a long time period, a coating solution for forming the oxide film, and an optical member using the oxide film.

Further features of the present invention will become apparent from the following description of exemplary embodiments with reference to the attached drawings.

### BRIEF DESCRIPTION OF THE DRAWINGS

FIG. 1 is a view illustrating a method for quantitative evaluation of a size of a peak in an infrared absorption spectrum of an oxide film containing Si in the present invention.

FIG. 2 is a front view of an optical member according to Example 9 of the present invention.

FIG. 3 is a sectional view of the optical member according to Example 9 of the present invention.

FIG. 4 is a front view of an optical member according to Example 10 of the present invention.

FIG. 5 is a sectional view of the optical member according to Example 10 of the present invention.

FIG. 6 is a front view of an optical member according to Example 11 of the present invention.

FIG. 7 is a sectional view of the optical member according to Example 11 of the present invention.

FIG. 8 is a front view of an optical member according to Example 12 of the present invention.

FIG. 9 is a sectional view of the optical member according to Example 12 of the present invention.

FIG. 10 is a sectional view of an optical system of Example 13 of the present invention.

FIG. 11 is a sectional view of an optical system of Example 14 of the present invention.

FIG. 12 is a sectional view of an optical system of Example 15 of the present invention.

FIG. 13 is a sectional view of an optical system of Example 16 of the present invention.

FIG. 14 is a view illustrating the infrared absorption spectrum of a coating solution of Example 1 of the present invention.

FIG. 15 is a view illustrating the infrared absorption spectrum of an applied film of Example 1 of the present invention.

### BEST MODE FOR CARRYING OUT THE INVENTION

Hereinafter, the present invention is described in detail. An oxide film according to the present invention relates to an oxide film containing an Si component, and is characterized in that a relative intensity ratio B/A of an absorption peak intensity B at a wavenumber of 1,000 to 850 cm⁻¹ assigned to an Si—O-M bond (where M represents H or a metal element) to an absorption peak intensity A at a wavenumber of 1,200 to 1,000 cm⁻¹ assigned to an Si—O bond in an infrared absorption spectrum measurement of the film is 0.86 or more to 1.02 or less. In addition, an optical member according to the present invention is characterized by including the oxide film according to the present invention on a base material. Multiple layers may be formed on the base material as long as one layer of the multiple layers is the oxide film of the present invention.

As a result of extensive studies, the inventors of the present invention have obtained an oxide film containing an Si component and illustrating small changes in its optical characteristics such as a transmittance even when left to stand at high temperature and high humidity for a long time period. In addition, the inventors have measured the infrared absorption spectrum of the oxide film illustrating small changes in its optical characteristics. As a result, the inventors have found that the relative intensity ratio B/A of the absorption peak intensity B at a wavenumber of 1,000 to 850 cm⁻¹ assigned to an Si—O-M bond (where M represents H or a metal element) to the absorption peak intensity A at a wavenumber of 1,200 to 1,000 cm⁻¹ assigned to an Si—O bond falls within the range of 0.86 or more to 1.02 or less.

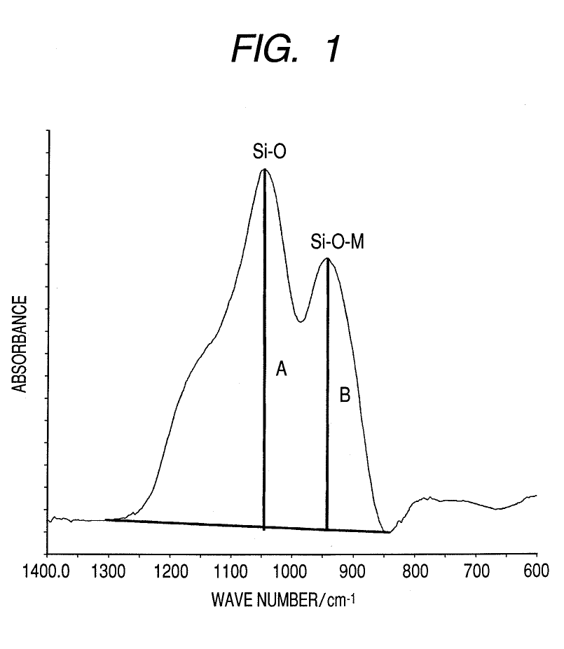

FIG. 1 is a view illustrating a method for quantitative evaluation of a size of a peak in the infrared absorption spectrum of the oxide film containing Si in the present invention. In the figure, a line connecting a local minimum between 1,350 cm⁻¹ and 1,250 cm⁻¹, and a local minimum between 900 cm⁻¹ and 850 cm⁻¹ is defined as a baseline. A point on the baseline at the wavenumber at which each peak shows the maximum absorbance is represented as a point of intersection. The length of a straight line connecting a local maximum point illustrating the maximum peak absorbance and the point of intersection is defined as an absorption peak height. An absorption peak height at 1,200 to 1,000 cm⁻¹ assigned to an Si—O bond is represented by A, and an absorption peak height at 1,000 to 850 cm⁻¹ assigned to an Si—O-M bond is represented by B. The inventors have found that, as long as a relative intensity ratio B/A between the heights is 0.86 or more to 1.02 or less, fluctuations in characteristics of the film can be suppressed even when the film is left to stand under a high-temperature, high-humidity environment for a long time period. Although many aspects of a mechanism for describing the reason why the above-mentioned relative intensity ratio is preferable are currently unclear, a film having Si—O and Si—O-M bonds and illustrating strong resistance against high-temperature, high-humidity environmental conditions or hot water environmental conditions may be obtained in the above-mentioned range.

M in the above-mentioned Si—O-M bond is not particularly limited as long as M represents H or a metal element; M preferably represents any one of, for example, Ti, Zr, and Al in consideration of the ease with which the Si—O-M bond is formed.

The oxide film containing Si in the optical member of the present invention desirably has a thickness of 5 nm or more to 150 nm or less, preferably 30 nm or more to 100 nm or less, or more preferably 50 nm or more to 90 nm or less in consideration of the constitution of an optical film. When the thickness is smaller than 5 nm, the film cannot exert a sufficient effect on the migration of, for example, an alkali from the base material or the like. When the thickness is larger than 150 nm, the film contributes to the reflection-reducing effect of the optical member to a reduced extent owing to interference or the like.

The oxide film containing Si of the present invention is characterized by being an oxide containing at least an Si element. A method of producing the oxide containing an Si element is not limited, and the oxide can be formed by any one of the conventional methods such as vapor phase methods including CVD and PVD, and liquid phase methods including the sol-gel method; the sol-gel method is preferably employed.

### (Production Method)

Next, a production method employing the sol-gel method as one embodiment of a method of producing each of the oxide film of the present invention and the optical member of the present invention using the oxide film is described.

In one embodiment, the oxide film of the present invention is produced by a method involving using a coating solution to be described later. In one embodiment, the optical member is produced by a method involving applying the coating solution onto the base material to form the oxide film. Multiple layers may be formed on the base material as long as one layer of the multiple layers is the oxide film of the present invention.

A compound of an element such as Si, Ti, Zr, or Al is used as a raw material for the coating solution. A salt compound such as an alkoxide, chloride, or nitrate of each metal can be used as the compound of an element such as Si, Ti, Zr, or Al; a metal alkoxide is preferably used from the viewpoint of film formability.

For the silicon alkoxide, various kinds of compounds expressed by the general formula Si(OR)₄ may be used. R is the same or different lower alkyl group such as a methyl group, an ethyl group, a propyl group, an isopropyl group, a butyl group, or an isobutyl group.

Titanium alkoxides include, for example, tetramethoxy titanate, tetraethoxy titanate, tetra n-propoxy titanate, tetraisopropoxy titanate, tetra n-butoxy titanate, and tetraisobutoxy titanate.

Specific examples of zirconium alkoxides include zirconilum tetramethoxide, zirconium tetraethoxide, zirconium tetra n-propoxide, zirconium tetraisopropoxide, zirconium tetra n-butoxide, and zirconium tetra-t-butoxide.

Aluminum compounds include, for example, aluminum ethoxide, aluminum isopropoxide, aluminum-n-butoxide, aluminum-sec-butoxide, aluminum-tert-butoxide, aluminum acetylacetnate or oligomers of these compounds, aluminum nitrate, aluminum chloride, aluminum acetate, aluminum phosphate, aluminum sulfate, and aluminum hydroxide.

In the present invention, a ratio between a silicon compound and at least one kind of a compound out of the compounds of titanium, zirconium, and aluminum is preferably as follows: the amount of the at least one kind of a compound out of the compounds of titanium, zirconium, and aluminum is 0.01 part by weight or more to 15,000 parts by weight or less with respect to 100 parts by weight of the silicon compound; the amount of the at least one kind is more preferably 0.05 part by weight or more to 10,000 parts by weight or less. When the amount deviates from the above-mentioned range, there is a possibility that a film having Si—O and Si—O-M bonds and illustrating strong resistance against high-temperature, high-humidity environmental conditions or hot water environmental conditions cannot be obtained.

A solution of a compound of each of silicon, titanium, zirconium, and aluminum is prepared by dissolving the compound of each of silicon, titanium, zirconium, and aluminum in an organic solvent. A molar ratio of the amount of the organic solvent to be added to the amount of the compound of each of silicon, titanium, zirconium, and aluminum is preferably about 20.

It should be noted that the expression “molar ratio of the amount of A to be added to the amount of B is 20” as used in the present invention refers to a state where the number of moles of A to be added is 20 times as large as the number of moles of B.

Examples of the organic solvent include: alcohols such as methanol, ethanol, 2-propanol, butanol, ethylene glycol, and ethylene glycol-mono-n-propyl ether; various kinds of aliphatic or aliyclic hydrocarbons such as n-hexane, n-octane, cyclohexane, cyclopentane, and cyclooctane; various kinds of aromatic hydrocarbons such as toluene, xylene, and ethyl benzene; various kinds of esters such as ethyl formate, ethyl acetate, n-butyl acetate, ethylene glycol monomethyl ether acetate, ethylene glycol monoethyl ether acetate, and ethylene glycol monobuthyl ether acetate; various kinds of ketones such as acetone, methyl ethyl ketone, methyl isobutyl ketone, and cyclohexanone; various kinds of ethers such as dimethoxy ethane, tetrahydrofuran, dioxane, and diisopropyl ether; various kinds of chlorinated hydrocarbons such as chloroform, methylene chloride, carbon tetrachloride, and tetrachloroethane; and aprotic polar solvents such as N-methyl pyrrolidone, dimethyl formamide, dimethyl acetamide, and ethylene carbonate. In preparing the coating solution of the present invention, of the various kinds of solvents described above, alcohols are preferably used in terms of stability of a solution.

If an alkoxide raw material is used, particularly titanium, zirconium, and alkoxides of aluminum are highly reactive to water, and are abruptly hydrolyzed by addition of moisture in air or water, resulting in opacity and precipitation. Zinc salt compounds are hard to be dissolved in an organic solvent alone, and the stability of their solutions is low.

For prevention of such a situation, a stabilizer is preferably added to stabilize the solution. Stabilizers may include, for example: β-diketone compounds such acetyl acetone, dipyrobilemethane, trifluoroacetylacetone, hexafluoroacetylacetone, benzoylacetone, and dibenzoylmethane; β-ketoester compounds such as methyl acetoacetate, ethyl acetoacetate, allyl acetoacetate, benzyl acetoacetate, iso-propyl acetoacetate, tert-butyl acetoacetate, iso-butyl acetoacetate, 2-methoxyethyl acetoacetate, and 3-keto-n-methyl valeriate; amines such as monoethanol amine, diethanol amine and triethanol amine; glycols such as ethylene glycol, glycerin, hexylene glycol, methyl cellosolve, ethyl cellosolve, butyl cellosolve, and phenyl cellosolve; and hydroxyketones such as acetol and acetoin. The amount of stabilizer to be added is preferably about 0.1 to 3 in terms of a molar ratio to the alkoxide.

When an alkoxide of a metal element such as titanium, zirconium, or aluminum and a stabilizer are mixed, the stabilizer coordinates to the metal alkoxide, whereby an infrared absorption peak is observed. In the infrared absorption spectrum measurement of a coating solution for forming an oxide film containing Si to be obtained in the present invention, an absorption peak at about 1,050 cm⁻¹ assigned to an Si—O bond and a peak assigned to any one stabilizer in a coordinated state are observed. The peak assigned to any one stabilizer in a coordinated state is observed at about 1,700 to 1,500 cm⁻¹ because wavelength regions observed for the stabilizer and the metal alkoxide are different from each other. In order that a peak in the infrared absorption spectrum may be quantitatively evaluated for its size, a line connecting a local minimum between 1,250 cm⁻¹ and 1,150 cm⁻¹, and a local minimum between 1,000 cm⁻¹ and 900 cm⁻¹ is defined as a baseline. A point on the baseline at the wavenumber at which each peak shows the maximum absorbance is represented as a point of intersection. The length of a straight line connecting a local maximum point illustrating the maximum peak absorbance and the point of intersection is defined as an absorption peak height. An absorption peak height at about 1,050 cm⁻¹ assigned to an Si—O bond is represented by C, and a peak height at 1,700 to 1,500 cm⁻¹ assigned to the peak assigned to any one stabilizer in a coordinated state is represented by D. A relative intensity ratio D/C between the heights is desirably 0.0005 or more to 0.0500 or less, or preferably 0.0005 or more to 0.0480 or less. As a result of the measurement of the infrared absorption spectrum of an oxide film formed by using a coating solution in the above-mentioned range, the inventors have found that a film having the following characteristic can be obtained: the relative intensity ratio B/A of the peak intensity B at 1,000 to 850 cm⁻¹ assigned to an Si—O-M bond (where M represents H or a metal element) to the absorption peak intensity A at 1,200 to 1,000 cm⁻¹ assigned to an Si—O bond is 0.86 or more to 1.02 or less. The coating solution in the above-mentioned range can be obtained by, for example, increasing the addition amount of water in an acid catalyst to be added to a silica component or using a raw material having additionally high hydrolytic property. The use of the coating solution may result in the formation of a film illustrating strong resistance against high-temperature, high-humidity environmental conditions or hot water environmental conditions.

For example, when the addition amount of water in the acid catalyst is increased on condition that the amount of a stabilizer to be added to a titania component is small, the hydrolytic property and condensation polymerization reactivity of a titanium alkoxide become high, and hence the above-mentioned relative intensity ratio D/C becomes less than 0.0005 and the relative intensity ratio B/A of the film becomes less than 0.86 in some cases. On the other hand, when the addition amount of water in the acid catalyst to be added to the silica component is small, the hydrolytic property and condensation polymerization reactivity of the silicon alkoxide are low, and hence the above-mentioned relative intensity ratio D/C exceeds 0.0500 and the relative intensity ratio B/A of the film exceeds 1.02 in some cases. In such range, it becomes difficult to obtain a film illustrating strong resistance against high-temperature, high-humidity environmental conditions or hot water environmental conditions.

The oxide oligomers of the coating solution for forming an oxide film containing Si to be obtained in the present invention have an average particle diameter of desirably 1 nm or more to 50 nm or less, or preferably 2 nm or more to 30 nm or less. When the average particle diameter is excessively small, a film having stable quality cannot be obtained. When the average particle diameter exceeds 50 nm, a film having a large grain boundary gap may be obtained, and hence there is a possibility that a film illustrating strong resistance against high-temperature, high-humidity environmental conditions or hot water environmental conditions cannot be obtained.

For example, when an aluminum oxide multi-component coating solution containing a silicon alkoxide is prepared, a solution containing the silicon alkoxide and a solution containing an aluminum compound are mixed. Prior to the mixing, water or a catalyst is preferably added to the solution containing the silicon alkoxide in advance so that part of alkoxyl groups may be hydrolyzed.

Catalysts may include, for example, nitric acid, hydrochloric acid, sulfuric acid, phosphoric acid, acetic acid, and ammonia.

When the oxide film is formed using the coating solution free of stabilizer, atmosphere upon applying is set to preferably an inert gas atmosphere such as dry air or dry nitrogen. The relative humidity of the dry atmosphere is set to preferably 30% or less.

As a solution applying method of forming an oxide film, for example, a know coating method such as a dipping method, a spin coating method, a spray method, a printing method, a flow coating method, and a combination thereof may be appropriately employed. The thickness of the film can be controlled by changing, for example, a lifting speed in the dipping method or the speed at which a substrate rotates in the spin coating method and changing the concentration of the coating solution. Of those parameters, the lifting speed in the dipping method can be appropriately selected depending on a required thickness; after having been immersed in the solution, the substrate is preferably lifted at a gentle, uniform speed of, for example, about 0.1 to 3.0 mm/sec.

The oxide film containing Si of the present invention has only to be dried at room temperature for about 30 minutes. In addition, the film can be dried or treated with heat at an additionally high temperature as required; as the temperature at which the film is treated with heat increases, an irregular structure having higher stability can be formed.

A plate crystal layer containing aluminum oxide can be formed on the oxide film containing an Si component of the present invention. A plate crystal of which the layer is formed is a crystal mainly formed of a hydroxide of aluminum or a hydrate of an aluminum oxide, and boehmite is a particularly preferable crystal of such kind. The crystal mainly formed of a hydroxide of aluminum or a hydrate of an aluminum oxide refers to a crystal containing the hydroxide of aluminum or the hydrate of the aluminum oxide at a content of more than 50 mol %.

The plate crystal layer containing aluminum oxide is formed by immersing, in hot water, a gel film formed by applying a coating solution containing an aluminum compound. Alternatively, the layer can be formed by immersing, in hot water, an aluminum oxide multi-component gel film. The aluminum oxide multi-component gel film refers to a film formed by applying a coating solution containing at least one kind of a compound selected from the compounds of zirconium, silicon, titanium, and zinc, and an aluminum compound at minimum.

When the aluminum oxide multi-component gel film is immersed in hot water, the surface layer of the aluminum oxide multi-component gel film receives, for example, a deflocculating action, and hence part of the components of the film are eluted. However, the plate crystal mainly containing aluminum oxide precipitates and grows on the surface layer of the gel film owing to a difference in solubility in hot water between various hydroxides. It should be noted that the temperature of hot water is preferably 40° C. to 100° C. The time period for which the gel film is treated with hot water is about 5 minutes to 24 hours. Since crystallization is performed by using a difference in solubility in hot water between the respective components in such treatment of the aluminum oxide multi-component gel film with hot water, the size of the plate crystal can be controlled over a wide range by changing the composition of an inorganic component. As a result, fine irregularities formed by the plate crystal can be controlled over the wide range. Further, when zinc oxide is used as an accessory component, zinc oxide and aluminum oxide can be turned into a eutectoid. As a result, the zinc oxide component can be incorporated into the plate crystal, the refractive indices of the fine irregularities formed by the plate crystal can be controlled, and excellent antireflection performance can be realized.

As described above, the formation of the plate crystal layer containing aluminum oxide on the oxide film containing an Si component of the present invention can minimize changes in optical characteristics of the oxide film due to the immersion of the film in hot water. As a result, a layer having a refractive index which is intermediate between the refractive index of the base material and the refractive index of the plate crystal layer can be stably interposed between the base material and the plate crystal layer by the oxide film containing an Si component of the present invention. Accordingly, the refractive index of the entire optical member gradually reduces from the base material to the surface of the plate crystal layer, whereby the antireflection effect of the optical member can be significantly improved.

Examples of the base material to be used in the optical member of the present invention include glass, a plastic base material, a glass mirror, and a plastic mirror. Representative examples of the plastic base material include: films and molded articles of thermoplastic resins such as polyester, triacetylcellulose, cellulose acetate, polyethylene terephthalate, polypropylene, polystyrene, polycarbonate, polymethyl methacrylate, an ABS resin, polyphenylene oxide, polyurethane, polyethylene, and polyvinyl chloride; and crosslinked films and crosslinked molded articles obtained from various thermosetting resins such as an unsaturated polyester resin, a phenol resin, crosslinkable polyurethane, a crosslinkable acrylic resin, and a crosslinkable, saturated polyester resin. Specific examples of the glass include a no-alkali glass, an alumino-silicate glass, a borosilicate glass, a lanthanum-based glass, and a titanium-based glass.

A transparent base material to be used in the present invention has only to be such that the base material can be finally formed into a shape in accordance with an intended purpose. A flat plate, film, sheet, or the like is used, and a base material having a two- or three-dimensional curved surface is also permitted. The thickness of the base material can be appropriately determined, and is generally, but not limited to, 5 mm or less.

The oxide film containing an Si component of the present invention can be further provided with layers for imparting various functions as well as the above-mentioned layer. For example, the film can be provided with a hard coat layer for improving the hardness of the film, and can be provided with an adhesive layer or primer layer for improving adhesiveness between the transparent base material and the hard coat layer. As described above, the refractive index of any other layer to be provided between the transparent base material and the hard coat layer is preferably intermediate between the refractive index of the transparent base material film and the refractive index of the hard coat layer.

Hereinafter, the present invention is specifically described by way of examples; provided that the present invention is not limited to the examples.

An oxide film obtained in each of examples and comparative examples was evaluated by the following methods.

### (1) Measurement of Infrared Absorption Spectrum (IR)

Infrared absorption spectrum measurement was performed under the following conditions. A Spectrum One manufactured by PerkinElmer Japan was used as an apparatus, and a single reflection ATR apparatus manufactured by PerkinElmer Japan was used as an ATR attachment.

### (1-1) Measurement for Oxide Film

A substrate on which the oxide film had been formed was fixed to a jig, and the infrared absorption spectrum of the oxide film was measured.

### (1-2) Measurement for Coating Solution

A diamond/ZnSe prism was used as a prism. A coating solution was dropped to the diamond/ZnSe prism, and the infrared absorption spectrum of the coating solution was measured.

### (2) Measurement of Particle Diameters of Coating Solution

The measurement was performed by using a Zetasizer Nano S manufactured by Malvern Instruments Ltd.

### (3) Measurement of Transmittance

The transmittance of the oxide film was measured with a spectrophotometer manufactured by Hitachi, Ltd. (U-4000 model). An angle of incidence at the time of the transmittance measurement was 0°.

Tables 1 and 2 show the results of the above-mentioned measurement.

### Example 1

Tetraethoxysilane (TEOS), ethanol (EtOH), and 0.01 M (HCl aq.) were mixed, and the mixture was stirred for about 6 hours at room temperature, whereby an SiO₂ sol solution was prepared. The solution contained TEOS, EtOH, and HCl aq. at a molar ratio of 1:4:3. After that, the solution was diluted with EtOH, whereby an SiO₂ sol solution was prepared. Meanwhile, titanium-n-butoxide (Ti(O-n-Bu)₄) was added to a mixed liquid of EtOH and ethyl acetoacetate (EAcAc), and the whole was stirred for about 3 hours at room temperature, whereby a TiO₂ sol solution was prepared. The solution contained Ti(O-n-Bu)₄, EtOH, and EAcAc at a molar ratio of 1:20:1. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared.

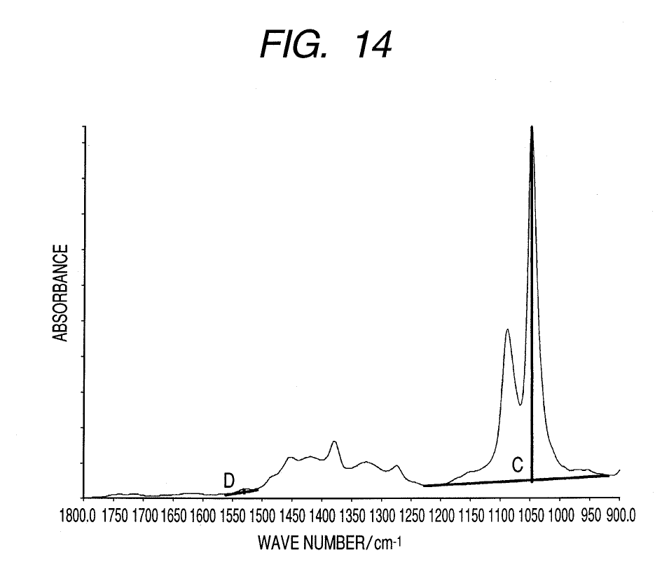

The infrared absorption spectrum of the resultant coating solution was measured. FIG. 14 is a view illustrating the infrared absorption spectrum of the coating solution of Example 1. In the figure, an absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0046. The measured average particle diameter of the coating solution was about 8 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm.

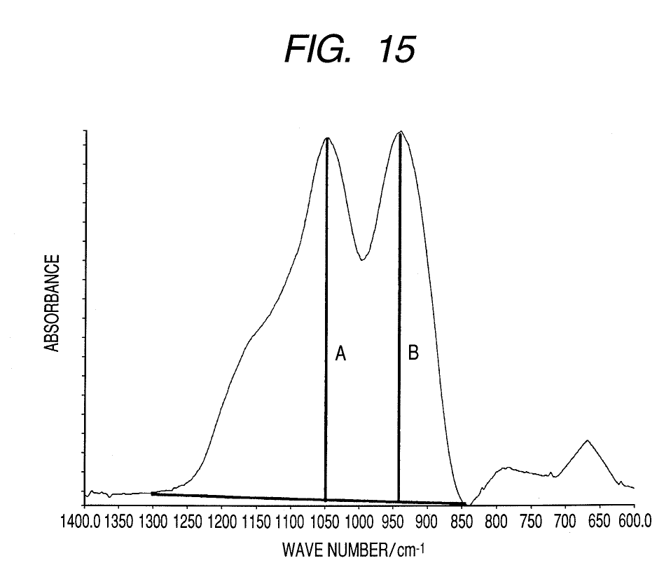

The infrared absorption spectrum of the resultant applied film was measured. FIG. 15 is a view illustrating the infrared absorption spectrum of the applied film of Example 1. In the figure, the relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the resultant applied film was 1.02.

The above-mentioned SiO₂—TiO₂-based gel film was produced on a substrate obtained by: polishing both surfaces of an S-TIH53 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described below. Al(O-sec-Bu)₃ was dissolved in IPA, EAcAc was added to the solution, and the mixture was stirred for about 3 hours at room temperature. Further, HCl aq. diluted with IPA was added to the solution, and the mixture was stirred for about 3 hours at room temperature, whereby an Al₂O₃ sol solution was prepared. Here, the solution contained Al(O-sec-Bu)₃, IPA, EAcAc, and HCl aq. at a molar ratio of 1:20:0.5:1. Further, the sol solution was refluxed for about 6 hours.

Next, an applied film was formed by using the Al₂O₃ sol on the SiO₂—TiO₂-based gel film by a dipping method (at a lifting speed of 0.5 mm/sec, 20° C., and 56% R.H.). After having been dried, the resultant was treated with heat at 200° C. for 10 minutes. Further, film formation was repeatedly performed under the above-mentioned conditions twice, and the resultant was treated with heat at 200° C. for 30 minutes, whereby a transparent gel film was obtained. The film had a thickness of about 200 nm. Next, the resultant was immersed in hot water at 80° C. for 30 minutes, and was then dried at 60° C. for 30 minutes.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.6%, and the transmittance 500 hours after the initiation was 99.1%.

### Example 2

Tetramethoxysilane (TMOS), EtOH, and 0.01 M (HCl aq.) were mixed, and the mixture was stirred for about 6 hours at room temperature, whereby an SiO₂ sol solution was prepared. The solution contained TMOS, EtOH, and HCl aq. at a molar ratio of 1:4:3. After that, the solution was diluted with EtOH, whereby an SiO₂ sol solution was prepared. Meanwhile, Ti(O-n-Bu)₄ was added to a mixed liquid of EtOH and EAcAc, and the whole was stirred for about 3 hours at room temperature, whereby a TiO₂ sol solution was prepared. The solution contained Ti(O-n-Bu)₄, EtOH, and EAcAc at a molar ratio of 1:20:1. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0048. The measured average particle diameter of the coating solution was about 7 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. In the figure, the relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the obtained film was 0.95.

The above-mentioned SiO₂—TiO₂-based gel film was produced on a substrate obtained by: polishing both surfaces of an S-TIH53 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.6%, and the transmittance 500 hours after the initiation was 99.3%.

### Example 3

TEOS, ethanol EtOH, and 0.01 M (HCl aq.) were mixed, and the mixture was stirred for about 6 hours at room temperature, whereby an SiO₂ sol solution was prepared. The solution contained TEOS, EtOH, and HCl aq. at a molar ratio of 1:4:3. After that, the solution was diluted with EtOH, whereby an SiO₂ sol solution was prepared. Meanwhile, Ti(O-n-Bu)₄ was added to a mixed liquid of EtOH and EAcAc. The whole was stirred for about 3 hours at room temperature, and 0.01 M (Hcl ag.) was then added whereby a TiO₂ sol solution was prepared. The solution contained Ti(O-n-Bu)₄, EtOH, EAcAc, and HCl ag. at a molar ratio of 1:20:0.3:1. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0005. The measured average particle diameter of the coating solution was about 5 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. The relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the obtained film was 0.86.

The above-mentioned SiO₂—TiO₂-based gel film was produced on a substrate obtained by: polishing both surfaces of an S-TIH53 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.5%, and the transmittance 500 hours after the initiation was 98.8%.

### Example 4

TEOS, EtOH, and 0.01 M (HCl aq.) were mixed, and the mixture was stirred for about 6 hours at room temperature, whereby an SiO₂ sol solution was prepared. The solution contained TEOS, EtOH, and HCl aq. at a molar ratio of 1:4:3. After that, the solution was diluted with EtOH, whereby an SiO₂ sol solution was prepared. Meanwhile, Ti(O-n-Bu)₄ was added to a mixed liquid of EtOH and acetyl acetone (AcAc), and the whole was stirred for about 3 hours at room temperature, whereby a TiO₂ sol solution was prepared. The solution contained Ti(O-n-Bu)₄, EtOH, and AcAc at a molar ratio of 1:20:2. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0459. The measured average particle diameter of the coating solution was about 2 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. The relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the resultant applied film was 1.02.

The above-mentioned SiO₂—TiO₂-based gel film was produced on a substrate obtained by: polishing both surfaces of an S-LAH65 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.7%, and the transmittance 500 hours after the initiation was 98.2%.

### Example 5

An SiO₂ sol was prepared in the same manner as in Example 1. Meanwhile, zirconium-iso-propoxide [Zr(O-iso-Pr)₄] was dissolved in 2-propanol [IPA], EAcAc was added to the solution, and the mixture was stirred for about 3 hours at room temperature, whereby a ZrO₂ sol solution was prepared. The solution contained Zr(O-iso-Pr)₄, IPA, and EAcAc at a molar ratio of 1:20:2. The ZrO₂ sol solution was added to the SiO₂ sol solution so that a weight ratio “SiO₂:ZrO₂” might be 0.7:0.3, and the mixture was stirred for about 3 hours at room temperature. Thus, a coating solution as an SiO₂—ZrO₂ sol was prepared. The infrared absorption spectrum of the resultant coating solution was measured. As a result, an absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0098. The measured average particle diameter of the coating solution was about 4 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—ZrO₂-based gel film was obtained. The film had a thickness of about 80 nm. The relative intensity ratio B/A of a peak intensity B at 1,000 to 850 cm⁻¹ assigned to an Si—O—Zr bond to an absorption peak intensity A at 1,200 to 1,000 cm⁻¹ assigned to an Si—O bond of the obtained film was 1.01.

The above-mentioned SiO₂—ZrO₂-based gel film was produced on a substrate obtained by: polishing both surfaces of an S-TIH53 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.4%, and the transmittance 500 hours after the initiation was 98.7%.

### Example 6

An SiO₂ sol was prepared in the same manner as in Example 1. Meanwhile, aliminium-sec-butoxide (Al(O-sec-Bu)₃) was dissolved in IPA, EAcAc was added to the solution, and the mixture was stirred for about 3 hours at room temperature, whereby a Al₂O₃ sol solution was prepared. The solution contained Al(O-sec-Bu)₃, IPA, and EAcAc at a molar ratio of 1:20:2. The Al₂O₃ sol solution was added to the SiO₂ sol solution so that a weight ratio “SiO₂:Al₂O₃” might be 0.7:0.3, and the mixture was stirred for about 3 hours at room temperature. Thus, a coating solution as an SiO₂—Al₂O₃ sol was prepared. The infrared absorption spectrum of the resultant coating solution was measured. As a result, an absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0102. The measured average particle diameter of the coating solution was about 3 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—Al₂O₃-based gel film was obtained. The film had a thickness of about 80 nm. The relative intensity ratio B/A of a peak intensity B at 1,000 to 850 cm⁻¹ assigned to an Si—O—Al bond to an absorption peak intensity A at 1,200 to 1,000 cm⁻¹ assigned to an Si—O bond of the resultant applied film was 0.93.

The above-mentioned SiO₂—Al₂O₃-based gel film was produced on a substrate obtained by: polishing both surfaces of an S-TIH53 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.2%, and the transmittance 500 hours after the initiation was 98.8%.

### Example 7

The SiO₂ sol and TiO₂ sol were prepared in the same manner as in Example 1. A coating solution as an SiO₂—TiO₂ sol was prepared so that a weight ratio “SiO₂:TiO₂” might be 0.8:0.2. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0007. The measured average particle diameter of the coating solution was about 4 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. The relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the obtained film was 0.86.

The above-mentioned SiO₂—TiO₂-based gel film was produced on a substrate obtained by: polishing both surfaces of an S-TIH53 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 98.8%, and the transmittance 500 hours after the initiation was 97.6%.

### Comparative Example 1

TEOS, EtOH, and 0.01 M (HCl aq.) were mixed, and the mixture was stirred for about 6 hours at room temperature, whereby an SiO₂ sol solution was prepared. The solution contained TEOS, EtOH, and HCl aq. at a molar ratio of 1:1:1. After that, the solution was diluted with EtOH, whereby an SiO₂ sol solution was prepared. Meanwhile, Ti(O-n-Bu)₄ was added to a mixed liquid of EtOH and acetyl acetone (AcAc), and the whole was stirred for about 3 hours at room temperature, whereby a TiO₂ sol solution was prepared. The solution contained Ti(O-n-Bu)₄, EtOH, and AcAc at a molar ratio of 1:20:2. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to AcAc in a coordinated state to an infrared absorption peak intensity C at about 1,050 cm⁻¹ assigned to an Si—O bond was about 0.0553. The measured average particle diameter of the coating solution was about 1 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. The relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the obtained film was 1.06.

The above-mentioned SiO₂—TiO₂-based gel film was produced on a substrate obtained by: polishing both surfaces of an S-LAH65 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.2%, and the transmittance 500 hours after the initiation was 95.8%.

### Comparative Example 2

TEOS, EtOH, and 0.01 M (HCl aq.) were mixed, and the mixture was stirred for about 6 hours at room temperature, whereby an SiO₂ sol solution was prepared. The solution contained TEOS, EtOH, and HCl aq. at a molar ratio of 1:3:2. After that, the solution was diluted with EtOH, whereby an SiO₂ sol solution was prepared. Meanwhile, Ti(O-n-Bu)₄ was added to a mixed liquid of EtOH and acetyl acetone (AcAc), and the whole was stirred for about 3 hours at room temperature, whereby a TiO₂ sol solution was prepared. The solution contained Ti(O-n-Bu)₄, EtOH, and AcAc at a molar ratio of 1:20:2. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to AcAc in a coordinated state to an infrared absorption peak intensity C at about 1,050 cm⁻¹ assigned to an Si—O bond was about 0.0514. The measured average particle diameter of the coating solution was about 1 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. In the figure, the relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the obtained film was 1.08.

The above-mentioned SiO₂—TiO₂-based gel film was produced on a substrate obtained by: polishing both surfaces of an S-LAH65 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.3%, and the transmittance 500 hours after the initiation was 95.6%.

### Comparative Example 3

TEOS, EtOH, and 0.01 M (HCl aq.) were mixed, and the mixture was stirred for about 6 hours at room temperature, whereby an SiO₂ sol solution was prepared. The solution contained TEOS, EtOH, and HCl aq. at a molar ratio of 1:4:3. After that, the solution was diluted with EtOH, whereby an SiO₂ sol solution was prepared. Meanwhile, Ti(O-n-Bu)₄ was added to a mixed liquid of EtOH and EAcAc. The whole was stirred for about 3 hours at room temperature, and 0.01 M (HCl ag.) was then added, whereby a TiO₂ sol solution was prepared. The solution contained Ti(O-n-Bu)₄, EtOH, EAcAc, and HCl ag. at a molar ratio of 1:20:0.3:1.5. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0001. The measured average particle diameter of the coating solution was about 6 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. The relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the obtained film was 0.80.

The above-mentioned SiO₂—TiO₂-based gel film was produced on a substrate obtained by: polishing both surfaces of an S-LAH65 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.3%, and the transmittance 500 hours after the initiation was 96.2%.

### Comparative Example 4

TEOS, EtOH, and 0.01 M (HCl aq.) were mixed, and the mixture was stirred for about 6 hours at room temperature, whereby an SiO₂ sol solution was prepared. The solution contained TEOS, EtOH, and HCl aq. at a molar ratio of 1:4:3. After that, the solution was diluted with EtOH, whereby an SiO₂ sol solution was prepared. Meanwhile, Ti(O-n-Bu)₄ was added to a mixed liquid of EtOH and EAcAc. The whole was stirred for about 3 hours at room temperature, and 0.01 M (HCl ag.) was then added, whereby a TiO₂ sol solution was prepared. The solution contained Ti(O-n-Bu)₄, EtOH, EAcAc, and HCl ag. at a molar ratio of 1:20:0.5:1.5. The TiO₂ sol solution was added to the SiO₂ sol solution so that a weight ratio “SiO₂:TiO₂” might be 0.7:0.3, and the mixture was stirred for about 3 hours at room temperature, whereby a coating solution as an SiO₂—TiO₂ sol was prepared. The infrared absorption spectrum of the resultant coating solution was measured. An absorption peak assigned to EAcAc in a coordinated state was observed at about 1,530 cm⁻¹, and a relative intensity ratio D/C of an infrared absorption peak intensity D assigned to EAcAc in a coordinated state to an infrared absorption peak intensity C at about 1,050 cm⁻¹ assigned to an Si—O bond was about 0.0001. The measured average particle diameter of the coating solution was about 4 nm.

Next, an Si substrate measuring about 76 mm×20 mm and having a thickness of about 0.1 mm was washed. After that, the Si substrate was immersed in the coating solution, and an applied film was formed on the surface of the Si substrate by a dipping method (at a lifting speed of 0.5 mm/sec, 23° C., and 45% R.H.). After having been dried, the resultant was treated with heat at 200° C. for 10 minutes. Further, film formation was repeatedly performed under the above-mentioned conditions, and the resultant was treated with heat at 200° C. for 30 minutes, whereby a transparent, amorphous SiO₂—TiO₂-based gel film was obtained. The film had a thickness of about 80 nm. The relative intensity ratio B/A of a peak intensity B at 1,000 to 850 cm⁻¹ assigned to an Si—O—Ti bond to an absorption peak intensity A at 1,200 to 1,000 cm⁻¹ assigned to an Si—O bond of the resultant applied film was 0.83.

The above-mentioned SiO₂—TiO₂-based gel film was produced on a substrate obtained by: polishing both surfaces of an S-LAH65 glass species manufactured by OHARA INC. into a shape measuring about 76 mm×20 mm and having a thickness of about 1 mm; and washing the shape. Further, an aluminum oxide film was formed on the film. A coating solution for forming the aluminum oxide film, and a method of producing the film are as described in Example 1.

A high-temperature, high-humidity test at 60° C. and a humidity of 90% was performed for investigating the durability of the optical performance of the resultant optical member, and the transmittances of the optical member at the time of the initiation of the test and 500 hours after the initiation were measured. The transmittance at the time of the initiation was 99.2%, and the transmittance 500 hours after the initiation was 96.6%.

TABLE 1

| | | | IR relative |
|---|---|---|---|
| | IR relative intensity | Average particle | intensity |
| | ratio D/C of coating | diameter of coating | ratio B/A of |
| | solution | solution (nm) | application film |
| Example 1 | 0.0046 | 8 | 1.02 |
| Example 2 | 0.0048 | 7 | 0.95 |
| Example 3 | 0.0005 | 5 | 0.86 |
| Example 4 | 0.0459 | 2 | 1.02 |
| Example 5 | 0.0098 | 4 | 1.01 |
| Example 6 | 0.0102 | 3 | 0.93 |
| Example 7 | 0.0007 | 4 | 0.86 |
| Comparative | 0.0553 | 1 | 1.06 |
| Example 1 | | | |
| Comparative | 0.0514 | 1 | 1.08 |
| Example 2 | | | |
| Comparative | 0.0001 | 6 | 0.80 |
| Example 3 | | | |
| Comparative | 0.0001 | 4 | 0.83 |
| Example 4 | | | |

TABLE 2

High-temperature, high-humidity
test Results of measurement
of transmittance (%)
(at wavelength of 550 nm)

| | At time of initiation | 500 hours |
|---|---|---|
| Example 1 | 99.6 | 99.1 |
| Example 2 | 99.6 | 99.3 |
| Example 3 | 99.5 | 98.8 |
| Example 4 | 99.7 | 98.2 |
| Example 5 | 99.4 | 98.7 |
| Example 6 | 99.2 | 98.8 |
| Example 7 | 98.8 | 97.6 |
| Comparative | 99.2 | 95.8 |
| Example 1 | | |
| Comparative | 99.3 | 95.6 |
| Example 2 | | |
| Comparative | 99.3 | 96.2 |
| Example 3 | | |
| Comparative | 99.2 | 96.6 |
| Example 4 | | |

### Example 9

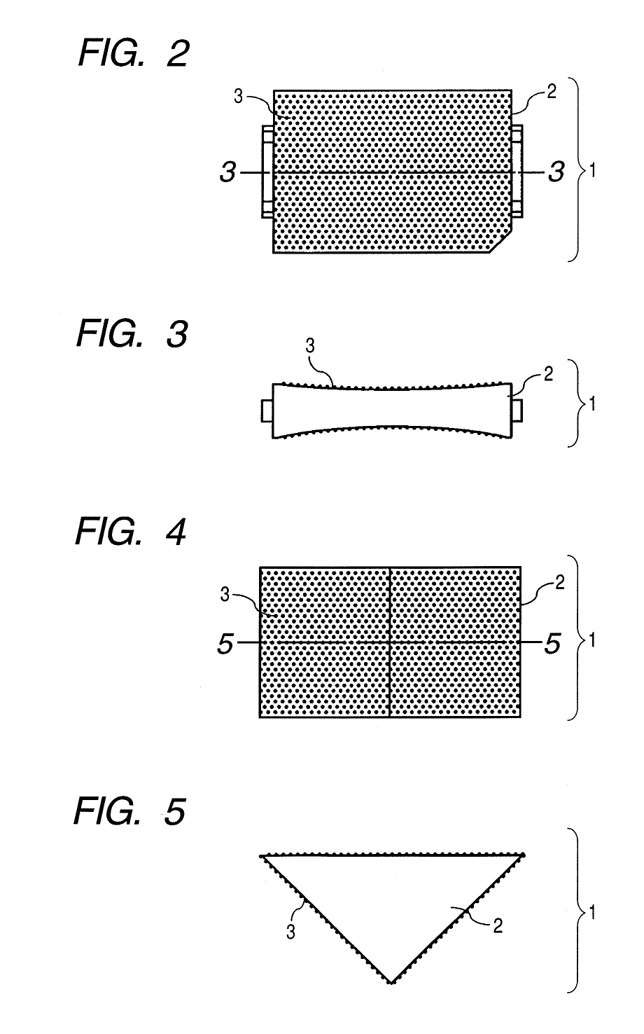

FIG. 2 is a front view of an optical member according to Example 9 of the present invention. In the figure, an optical member 1 is a concave lens, and is of such a structure that a substrate 2 is provided with an oxide film and plate crystal layer 3 according to the present invention.

FIG. 3 illustrates the section of the optical member according to Example 9 taken along the line 3-3 in FIG. 2. Light reflection at an optical surface is reduced because a film 3 having the plate crystal layer formed of a plate crystal mainly formed of aluminum oxide is formed on the oxide film containing an Si component in the optical surface.

Although the concave lens has been described in this example, the present invention is not limited to the lens, and a convex lens or meniscus lens is also permitted.

### Example 10

FIG. 4 is a front view of an optical member according to Example 10 of the present invention. In the figure, an optical member 1 is a prism lens, and is of such a structure that a substrate 2 is provided with an oxide film and plate crystal layer 3 according to the present invention.

FIG. 5 illustrates the section of the optical member according to Example 10 taken along the line 5-5 in FIG. 4. Light reflection at an optical surface is reduced because a film 3 having the plate crystal layer formed of a plate crystal mainly formed of aluminum oxide is formed on the oxide film containing an Si component in the optical surface.

Although the case where an angle formed between two adjacent optical surfaces of the prism is 90° or 45° has been described in this example, the present invention is not limited to the case, and a prism in which an angle formed between two adjacent optical surfaces is arbitrary is also permitted.

### Example 11

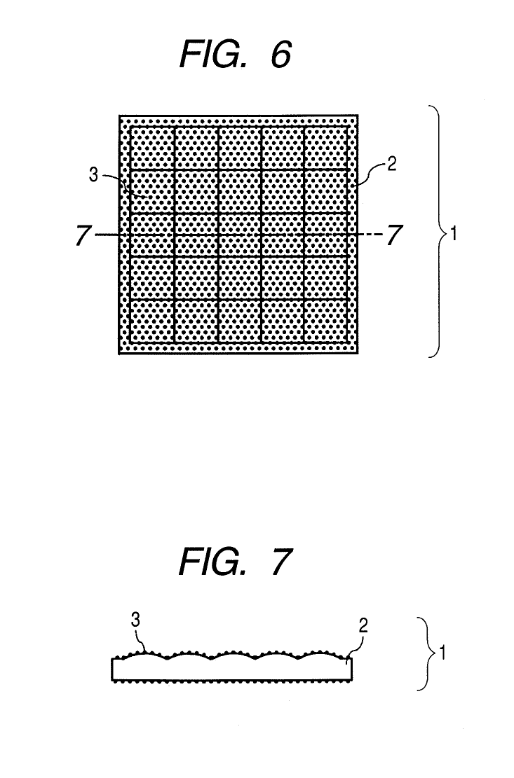

FIG. 6 is a front view of an optical member according to Example 11 of the present invention. In the figure, an optical member 1 is a flyeye integrator, and is of such a structure that a substrate 2 is provided with an oxide film and plate crystal layer 3 according to the present invention.

FIG. 7 illustrates the section of the optical member according to Example 6 taken along the line 7-7 in FIG. 6. Light reflection at an optical surface is reduced because a film 3 having the plate crystal layer formed of a plate crystal mainly formed of aluminum oxide is formed on the oxide film containing an Si component in the optical surface.

### Example 12

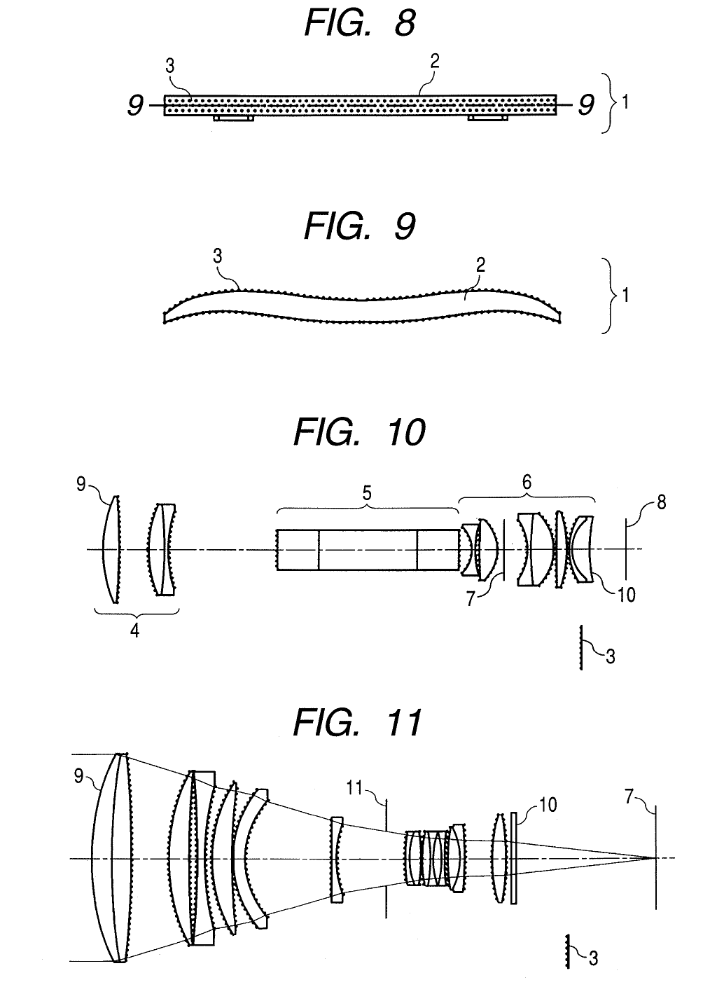

FIG. 8 is a front view of an optical member according to Example 12 of the present invention. In the figure, an optical member 1 is an fθ lens, and is of such a structure that a substrate 2 is provided with an oxide film and plate crystal layer 3 according to the present invention.

FIG. 9 illustrates the section of the optical member according to Example 12 taken along the line 9-9 in FIG. 8. Light reflection at an optical surface is reduced because a film 3 having the plate crystal layer formed of a plate crystal mainly formed of aluminum oxide is formed on the oxide film containing an Si component in the optical surface.

### Example 13

An example in which the optical member of the present invention is used in an observation optical system is described as Example 13 of the present invention. FIG. 10 illustrates the section of one optical system in a pair of optical systems of a pair of binoculars.

In the figure, the optical system includes an objective lens 4 for forming an observed image; a prism 5 (illustrated in a developed fashion) for inverting the image; an eyepiece 6; an image-forming surface 7; and a pupil surface 8 (evaluation surface). FIG. 10 illustrates that the oxide film and plate crystal layer 3 according to the present invention are formed on an optical surface. Light reflection at each optical surface is reduced by forming a film having the plate crystal layer formed of a plate crystal mainly formed of aluminum oxide on the oxide film containing an Si component in the optical surface as described above. In addition, in this example, neither an optical surface 9 of the objective lens closest to a substance nor an optical surface 10 of the eyepiece closest to the evaluation surface is provided with a plate crystal layer formed of a fine irregular structure because the performance of the plate crystal layer deteriorates owing to, for example, contact between the layer and any such surface during the use of the observation optical system. However, the present invention is not limited to the case, and a plate crystal layer may be provided for each of the optical surfaces 9 and 10.

### Example 14

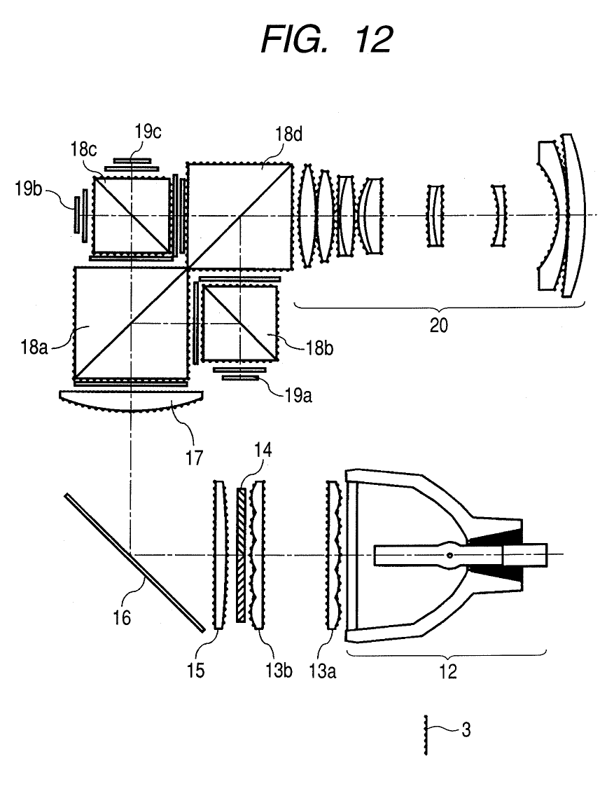

An example in which the optical member of the present invention is used in an imaging optical system is described as Example 14 of the present invention. FIG. 11 illustrates the section of an imaging lens (telephoto lens is illustrated here) of a camera or the like.

In the figure, the imaging lens includes a film as an image-forming surface or a solid-state image pick up device (photoelectric conversion device) such as CCD or CMOS, and a diaphragm 11. FIG. 11 illustrates that the oxide film and plate crystal layer 3 according to the present invention are formed on an optical surface. Light reflection at each optical surface is reduced by forming a film having the plate crystal layer formed of a plate crystal mainly formed of aluminum oxide on the oxide film containing an Si component in the optical surface as described above. In addition, in this example, an optical surface 9 of the objective lens closest to a substance is not provided with a plate crystal layer formed of a fine irregular structure because the performance of the plate crystal layer deteriorates owing to, for example, contact between the layer and any such surface during the use of the observation optical system. However, the present invention is not limited to the case, and a plate crystal layer may be provided for the optical surface 9.

### Example 15

An example in which the optical member of the present invention is used in a projector optical system (projector) is described as Example 15 of the present invention. FIG. 12 illustrates the section of the projector optical system.

In the figure, the projector optical system includes: a light source 12; flyeye integrators 13a and 13b; a polarization conversion device 14; a condenser lens 15; a mirror 16; a field lens 17; prisms 18a, 18b, 18c, and 18d; an light modulation devices 19a, 19b, and 19c; and a projected lens 20. FIG. 12 illustrates that the oxide film and plate crystal layer 3 according to the present invention are formed on an optical surface. Light reflection at each optical surface is reduced by forming a film having the plate crystal layer formed of a plate crystal mainly formed of aluminum oxide on the oxide film containing an Si component in the optical surface as described above.

In addition, the oxide film of this example has so high heat resistance as to be capable of being used at the position of the flyeye integrator 13a close to the light source 12 and exposed to high heat without fear of the deterioration of the performance of the oxide film because the oxide film is formed of an inorganic component.

### Example 16

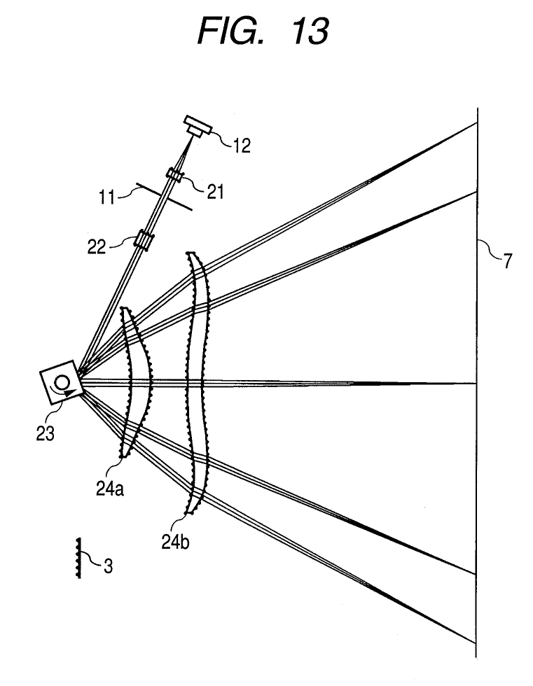

An example in which the optical member of the present invention is used in a scanning optical system (laser beam printer) is described as Example 16 of the present invention. FIG. 13 illustrates the section of the scanning optical system.

In the figure, the scanning optical system includes: a light source 12; a collimator lens 21; an aperture diaphragm 11; a cylindrical lens 22; a light deflector 23; fθ lenses 24a and 24b; and an image surface 7. The oxide film and plate crystal layer 3 according to the present invention are formed on an optical surface. Light reflection at each optical surface is reduced by forming a film having the plate crystal layer formed of a plate crystal mainly formed of aluminum oxide on the oxide film containing an Si component in the optical surface as described above, whereby the formation of a high-quality image is realized.

The oxide film of the present invention shows suppressed fluctuations in its characteristics even when left to stand under a high-temperature, high-humidity environment for a long time period, has significantly improved durability, and is stable over a long time period. Accordingly, the oxide film can be utilized in an optical member, an optical system such as an imaging optical system, observation optical system, projector optical system, or scanning optical system, or an optical apparatus.

This application claims the benefit of Japanese Patent Applications No. 2007-318955, filed Dec. 10, 2007 and No. 2008-308625, filed Dec. 3, 2008, which are hereby incorporated by reference herein in their entirety.

1. An oxide film comprising an Si component, wherein a relative intensity ratio B/A of an absorption peak intensity B at a wavenumber of 1,000 to 850 cm⁻¹ assigned to an Si—O-M bond where M represents H or a metal element to an absorption peak intensity A at a wavenumber of 1,200 to 1,000 cm⁻¹ assigned to an Si—O bond in infrared absorption spectrum measurement of the film is 0.86 or more to 1.02 or less.

2. The oxide film according to claim 1, wherein M in the Si—O-M bond represents any one of Ti, Zr, and Al.

3. The oxide film according to claim 1, wherein the oxide film comprising the Si component has a thickness of 5 nm or more to 150 nm or less.

4. The oxide film according to claim 1, wherein a plate crystal layer formed of a plate crystal containing aluminum oxide is present on the oxide film comprising the Si component.

5. The oxide film according to claim 4, wherein the plate crystal containing aluminum oxide is mainly formed of a hydroxide of aluminum or a hydrate of an aluminum oxide.

6. The oxide film according to claim 4, wherein the plate crystal layer is treated with hot water.

7. An optical member comprising the oxide film according to claim 1 on a base material.

8. A coating solution, which is used for forming an oxide film containing an Si component, wherein a relative intensity ratio D/C of an infrared absorption peak intensity D assigned to any one stabilizer in a coordinated state to an infrared absorption peak intensity C assigned to an Si—O bond is 0.0005 or more to 0.0500 or less.

9. The coating solution according to claim 8, wherein the stabilizer comprises any one of β-diketone compounds, β-keto ester compounds, amines, and glycols.

10. The coating solution according to claim 8, wherein oxide oligomers in the coating solution have an average particle diameter of 1 nm or more to 50 nm or less.

11. A method of producing an optical member, comprising applying a coating solution prepared so that a relative intensity ratio D/C of an infrared absorption peak intensity D assigned to any one stabilizer in a coordinated state to an infrared absorption peak intensity C assigned to an Si—O bond is 0.0005 or more to 0.0500 or less onto a base material to form an oxide film.
